(19) United States
(12) Patent Application Publication
(10) Pub. No.: US 2024/0037460 A1
(43) Pub. Date: Feb. 1, 2024

(54) SYSTEMS AND METHODS FOR ASSISTING WHEELCHAIR PASSENGERS

(71) Applicant: SMARTWEELS INC, Jamaica, NY (US)

(72) Inventor: Asmahan DAHBALI, Jamaica, NY (US)

(21) Appl. No.: 17/769,044

(22) PCT Filed: Oct. 17, 2019
(86) PCT No.: PCT/US2019/056660

§ 371 Date: Apr. 14, 2022

(51) Int. Cl. G06Q 10/02; G06Q 50/30; G06Q 10/0631; G06Q 30/04; G06Q 10/1053

(52) U.S. Cl. CPC G06Q 10/025; G06Q 50/30; G06Q 10/06311; G06Q 30/04; G06Q 10/1053

(57) ABSTRACT

Systems and methods for assisting wheelchair passengers where wheelchair assistance personnel utilize passenger information, airline information, and flight status information to assist passengers requiring wheelchairs. The flight status information is periodically updated. The systems and methods increase productivity of the wheelchair assistance personnel, which in turn reduces costs. The systems and methods also reduce or eliminate passenger waiting times and delays for a wheelchair.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to software that is a complete end-to-end wheelchair operations solution that encompasses products for airport operations, time & attendance (including payroll), invoicing, and human resources. The present invention is driven by multiple automated servers hosted in a cloud computing service, such as Microsoft Azure, feeding passenger and flight information to customers and employees (i.e. end-nodes). The end-nodes utilize the Wheelchair Assistance (WCA) applications specifically targeted for the airline and assisting wheelchair passengers. This system was designed and customized for managing customers, employees, and assets. It is flexible enough to be deployed to any terminal at any airport in the world. The present invention may be used to capture detailed information to assist wheelchair passengers including, but not limited to, arrival & departure flights, passengers waiting for pickup, in-transit, at the gate, pickup, and drop-off times. In addition, the present invention may contain integrated functionality (via add-ons) for human resources & staffing, and wheelchair inventory & damage reports.

### BRIEF SUMMARY OF THE INVENTION

An embodiment of the present invention is a computer system comprising; at least one processor unit; at least one memory unit coupled to the at least one processor unit; and, computer readable instructions embodied in the memory unit and executable by the processor unit, wherein execution of the instructions by the processor unit causes the computing system to perform a method of assisting a wheelchair passenger, the method comprises receiving passenger information, receiving airline information, making at least one request of flight status information to at least one flight status provider, receiving the flight status information from the at least one flight status provider, generating wheelchair assistance information, and, providing the wheelchair assistance information to a first recipient selected from the group consisting of a wheelchair assistance agent, a wheelchair assistance dispatcher, and combinations thereof.

Another embodiment of the present invention is a method of assisting a wheelchair passenger, the method comprises receiving passenger information, receiving airline information, making at least one request of flight status information to at least one flight status provider, receiving the flight status information from the at least one flight status provider, generating wheelchair assistance information, and, providing the wheelchair assistance information to a first recipient selected from the group consisting of a wheelchair assistance agent, a wheelchair assistance dispatcher, and combinations thereof.

Yet another embodiment of the present invention is a non-transitory computer readable medium having computer readable instructions embodied therein, the computer readable instructions being configured to implement a method of assisting a wheelchair passenger, the method comprises receiving passenger information, receiving airline information, making at least one request of flight status information to at least one flight status provider, receiving the flight status information from the at least one flight status provider, generating wheelchair assistance information, and, providing the wheelchair assistance information to a first recipient selected from the group consisting of a wheelchair assistance agent, a wheelchair assistance dispatcher, and combinations thereof.

In another embodiment of the present invention, the method of assisting a wheelchair passenger further comprises providing the wheelchair assistance information to a second recipient selected from a group consisting of an airline administrator, a passenger, and combinations thereof.

In yet another embodiment of the present invention, the method of assisting a wheelchair passenger further comprises receiving wheelchair assistance agent information from the wheelchair assistance agent, generating a work schedule, transmitting the work schedule to the wheelchair assistance agent, receiving time and attendance information from the wheelchair assistance agent, and, providing the time and attendance information to a wheelchair assistance administrator.

In another embodiment of the present invention, the method of assisting a wheelchair passenger further comprises generating billing and invoicing information, transmitting the billing and invoicing information to a wheelchair assistance administrator, receiving billing rate information from the wheelchair assistance administrator, generating an invoice, and, transmitting the invoice to an airline administrator.

In yet another embodiment of the present invention, the method of assisting a wheelchair passenger further comprises receiving job applicant requirements from a wheelchair assistance administrator, generating a job application, transmitting the job application to a job applicant, receiving job applicant qualifications from the job applicant, and, transmitting the job applicant qualifications to the wheelchair assistance administrator.

In another embodiment of the present invention, the method of assisting a wheelchair passenger further comprises receiving wheelchair assistance training information from a wheelchair assistance administrator, transmitting the wheelchair assistance training information to the wheelchair assistance agent, receiving a training completion confirmation from the wheelchair assistance agent, and, transmitting the training completion confirmation to the wheelchair assistance administrator.

In yet another embodiment of the present invention, the method of assisting a wheelchair passenger further comprises receiving a wheelchair assistance agent claim from the wheelchair assistance agent, transmitting the wheelchair assistance agent claim to a wheelchair assistance administrator, receiving a claim resolution from the wheelchair assistance administrator, and, transmitting the claim resolution to the wheelchair assistance agent.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a swim-lane diagram of an embodiment of the present invention.

FIG. 2 illustrates a process of assisting a wheelchair passenger.

FIG. 3 illustrates a computerized system of assisting a wheelchair passenger.

FIG. 4 is an example of a computing environment that can be utilized by embodiments of the present invention.

FIG. 5 illustrates an example of a computing system that can be configured to perform any of the processes of the present invention described herein.

FIG. 6 is a swim-lane diagram of an embodiment of the present invention.

FIG. 7 is a swim-lane diagram of an embodiment of the present invention.

FIG. 8 is a swim-lane diagram of an embodiment of the present invention.

FIG. 9 is a swim-lane diagram of an embodiment of the present invention.

FIG. 10 is a swim-lane diagram of an embodiment of the present invention.

For clarity purposes, all reference numerals may not be included in every figure.

### DETAILED DESCRIPTION OF THE INVENTION

The figures illustrate various embodiments of the present invention. Passengers 100, airline administrators 200, flight status providers 300, Wheelchair Assistance (WCA) dispatchers 500, WCA agents 600, WCA administrators 700, and job applicants 800 may access the WCA application 400 with an enabled computing device 301A, 301B, 301C.

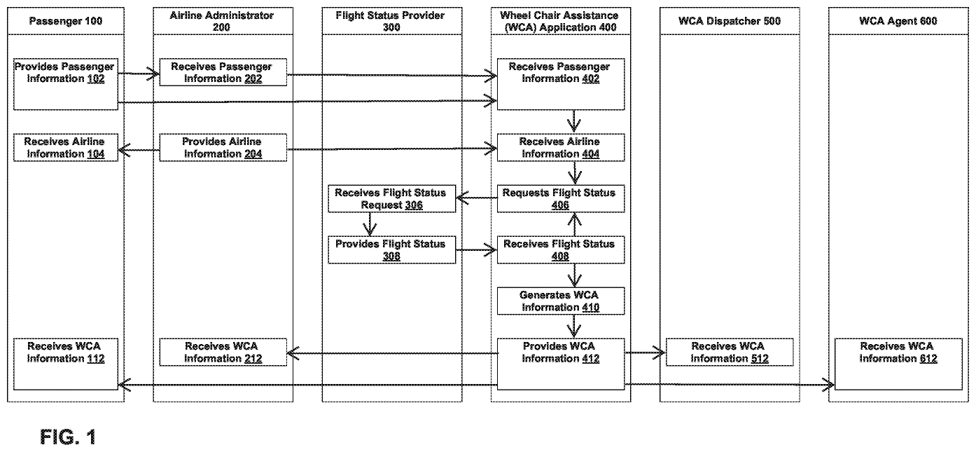

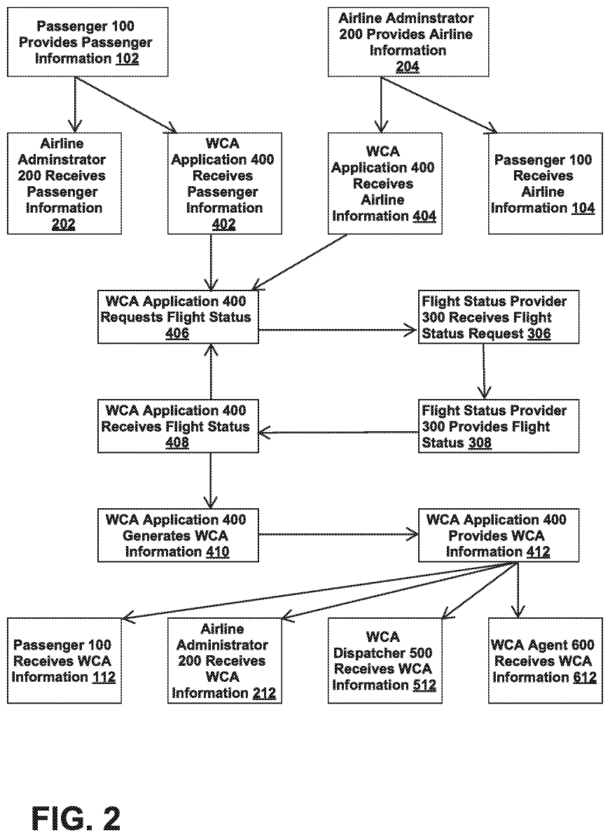

As illustrated in FIGS. 1 and 2, the WCA application 400 may be utilized to assist a passenger 100 in need of a wheelchair. A passenger 100 may provide passenger information to an airline administrator (102, 202). The passenger 100 may input the passenger information directly into the WCA application (102, 402). Alternatively, the airline administrator 200 may input the passenger information directly into the WCA application (202, 402). The airline administrator 200 may also input airline information directly into the WCA application (204, 404). The airline administrator 200 may also provide the passenger 100 with the airline information (104, 204).

Passenger information may include, but is not limited to, name, location, and other information. Airline information may include, but is not limited to, name, airport, terminal information, gate information, and other information.

After the WCA application 400 receives the passenger information (402) and the airline information (404), it may request flight status information from at least one flight status provider 300 (406, 306). The WCA application 400 may request flight status information periodically to be current with regard to the flight status. After receiving the flight status information from the flight status provider (308, 408), the WCA application 400 generates WCA information (410). The WCA information may be provided to and/or accessed by the passenger 100 (412, 112), the airline administrator 200 (412, 212), the WCA dispatcher 500 (412, 512) and the WCA agent 600 (412, 612).

Flight status information may include, but is not limited to, time of departure, time of arrival, delay information, and other information. Flight status providers may include, but is not limited to, AIMS and FlightView/OAG. Advantageously, more than one flight status provider may be used to create the best possible “picture” of the flight activity in/out of a terminal.

As an example, a passenger requiring a wheelchair may request a wheelchair through the WCA application directly by inputting passenger and airline information. The information will allow WCA personnel to have a wheelchair available at the time and place that the passenger needs it. Alternatively, the passenger may ask an airline administrator (e.g., airline reservationists, travel agent, check-in personnel) to request the wheelchair. The airline administrator will input the passenger and airline information into the WCA application. The WCA application would request flight status information from flight status providers on a periodic basis for updates to the flight status in the event of delays, early arrivals, etc. The WCA application will provide this wheelchair assistance information (including, but not limited to, passenger name, location, airline, expected pickup/drop off time) to a WCA agent or WCA dispatcher. The WCA agent may receive the information directly; alternatively, the WCA dispatcher receives the information and then dispatches a WCA agent to provide the wheelchair assistance to the passenger. When the WCA agent picks up a passenger at a specified location, the WCA agent may confirm doing so through the WCA application. When the WCA agent drops off the passenger at the specified location, the WCA agent may confirm doing so through the WCA application.

Advantageously, if a passenger is on an arriving flight, then the passenger will have a wheelchair waiting upon arrival. Also advantageously, the WCA agent is more efficient due to the updated flight status information via the WCA application. Another advantage is that all passengers in need of wheelchairs will have a wheelchair available at arrival. Passengers on departing flights have similar advantages. When a passenger arrives at the curb or check-in counter, a wheelchair and a WCA agent will be waiting to transport the passenger to the departure gate. Again, utilization of the WCA application provides WCA agent efficiency, ensures necessary wheelchairs availability, eliminates of passenger delays (especially for instances where the passenger has limited time between connecting flights), among other advantages.

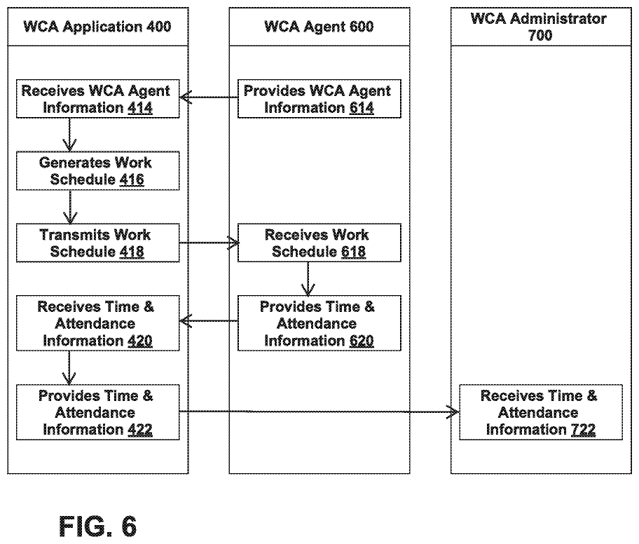

As illustrated in FIG. 6, the WCA application 400 may also be utilized to assist a WCA administrator 700 in managing a WCA agent's 600 time and attendance. The time and attendance functionality of the WCA application 400 helps track and monitor when employees start and stop work allowing the WCA application 400 to monitor the employees' working hours and late arrivals, early departures, time taken on breaks and absenteeism. It also helps to control labor costs by reducing over-payments, which are often caused by paying employees for time that are not working, and eliminates transcription errors, interpretation errors and intentional errors. This functionality provides all of the necessary hardware and software to create custom employee shifts & schedules, track attendance trends, and detailed data analysis and reporting. In addition, this functionality comes with an integrated time clock that helps reduce time-theft and increase security using two-factor authorization. Finally, this functionality may be fully compatible with most payroll systems and supports exporting to various formats.

The WCA agent 60 enters WCA agent information, such as availability into the WCA application 400 (614, 414). The WCA application 400 will then generate a work schedule for the WCA agent 600 (416). The WCA agent 600 receives the work schedule (418, 618) and when the WCA agent 600 works, the WCA application 400 records the times and days that the WCA agent 600 is working (620, 420). A WCA administrator 700 may utilize the WCA application 400 to view the WCA agent's 600 time and attendance information (422, 722).

WCA agent information may include, but is not limited to, agent name and identifier, start time, end time, and other information.

Time and attendance information may include, but is not limited to, working hours, overtime hours, late arrivals, early departures, time taken on breaks and absenteeism, vacation hours available/used/accrued sick hours available/used/accrued, and other information.

As an example, a WCA agent may log into the WCA application and enter WCA agent information that may affect the agent's upcoming work schedule. For example, if the agent requires time off for a doctor's appointment or vacation, then the agent enters the information into the WCA application. A WCA administrator would receive the agent's information and that will be taken into account when generating a work schedule.

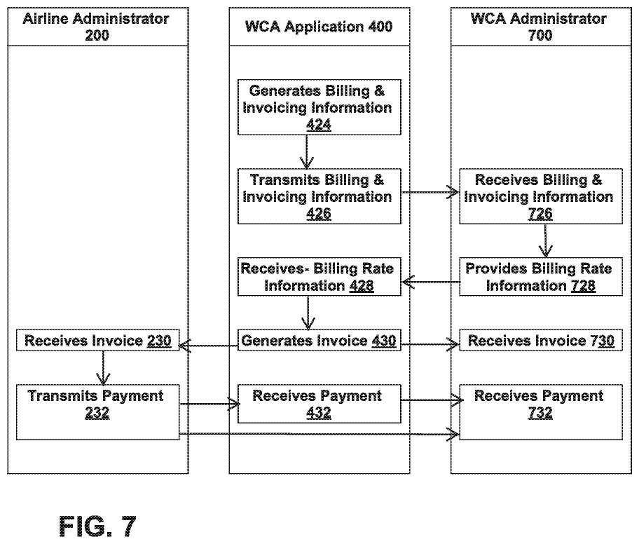

As illustrated in FIG. 7, the WCA application 400 may also be utilized to assist a WCA administrator 700 in billing and invoicing an airline administrator. The billing and invoicing functionality may allow authorized users to setup billing rates (by passenger, flight, or hour), define discount rates, billing cycles, detailed audits, and flexible invoicing formats. It supports invoicing individual passengers, flights, hours used, and subcontracted services. In addition, this functionality can pull detailed reports on all aspects of the financial system to help accounting departments identify money sinks and trouble spots. After an invoice is created, the functionality follows up to ensure that invoices are paid promptly with reminders going out periodically after the overdue mark.

After an airline and its passenger utilizes a wheelchair, the WCA application 400 may be used to generate billing information for a WCA administrator 700 for review (424, 426, 726). The WCA administrator 700 may input billing rate information for the airline administrator 200 into the WCA application 400 (728, 428). The WCA application 400 generates an invoice for the airline administrator 200 (430, 230). The WCA administrator 700 may also view the invoice on the WCA application 400 (430, 730). Upon receiving the invoice, the airline administrator 200 may transmit payment to the WCA administrator 700 through the WCA application 400 (232, 432) or directly to the WCA administrator 700 (232, 732).

Billing information may include, but is not limited to, wheelchair passenger names, airline names, number of wheelchairs used, and other information.

Billing rate information may include, but is not limited to, billing rates (by passenger, flight, or hour), define discount rates, billing cycles, detailed audits, flexible invoicing formats, and other information.

As an example, the WCA application will have most of the information necessary to create an invoice to bill either the airline or the passenger directly. A WCA administrator would receive billing information and may provide billing rate information, for example, a discounted rate for reaching a certain number of wheelchair uses per specified period of time. After the WCA administrator provides billing rate information, that may or may not alter the billing, an invoice is transmitted to the airline or the passenger.

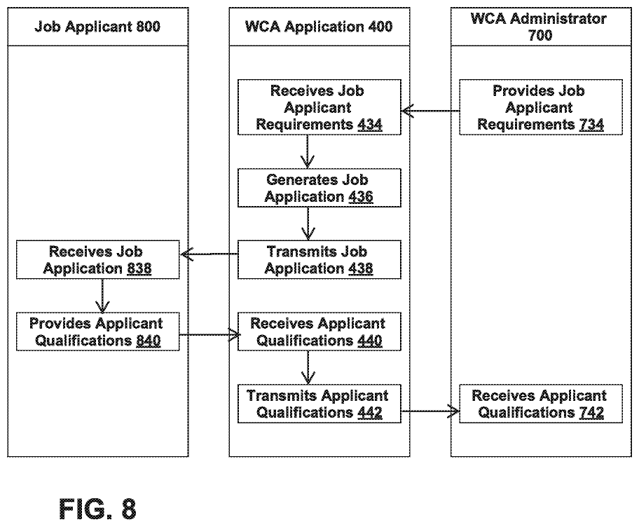

As illustrated in FIG. 8, the WCA application 400 may also be utilized to assist a WCA administrator 700 in finding qualified job applicants. The human resources functionality may be utilized for managing all staff information (e.g., providing training, addressing employee work related claims), processing new hires, personnel files & documents, and detailed change audits. This functionality allows authorized users to manage the recruitment processes (i.e., finding qualified job applicants), benefits administration and keep track of attendance records. It helps ensure everyday human resources processes are manageable and easy to access.

The WCA administrator 700 may input job applicant requirements for a position into the WCA application 400 (734, 434). The WCA application 400 generates a job application (436) for a job applicant 800 to view on the WCA application 400 (438, 838). The job applicant 800 may apply for the position by entering her qualifications into the WCA application 400 (840, 440). The WCA administrator 700 may review the job applicant's 800 qualifications to determine if the job applicant 800 qualifies for the position (442, 742).

Job applicant requirements and the job applicant's qualifications may include, but is not limited to, age limits, experience, certifications, resumes, and other information.

As an example, when a WCA administrator determines that a new employee is needed, the WCA administrator inputs the job requirements onto the WCA application. The WCA application then generates a job application. A job applicant will then be able to apply for the position by entering her qualifications through the WCA application. The WCA administrator can then review the job applicant's qualifications.

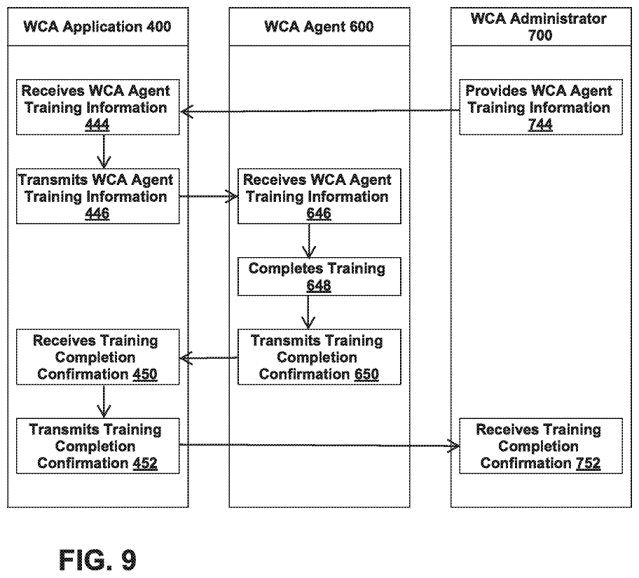

As illustrated in FIG. 9, the WCA application 400 may also be utilized to assist a WCA administrator 700 in providing training for a WCA agent 600. The WCA administrator 700 may input training information into the WCA application 400 (744, 444). A WCA agent 600 may then access the training information (446, 646). Once the WCA agent 600 completes the training (648), the WCA agent 600 may confirm that the training has been completed (650, 450). The WCA administrator 700 may utilize the WCA application 400 to see if the WCA agent 600 had completed the training (452, 752).

Training information may include, but is not limited to, videos, print material, links to training sites or applications, testing, and other information. Training confirmation may include information whether the WCA agent 600 successfully completed the training or not. For example, if the training is scored, the WCA application 400 will provide the WCA agent's 600 score and whether the score is a passing or failing score.

As an example, a WCA administrator may want training for new hires or existing WCA agents. To do so, the WCA administrator transmits the training materials to the employee through the WCA application. The employee then performs the required training regiment. In instances where the training regiment is through the WCA application, the training completion confirmation will be automatic upon completion of the training. In instances when the training regiment is not through the WCA application, the employee may provide confirmation of the completion of the training through the WCA application.

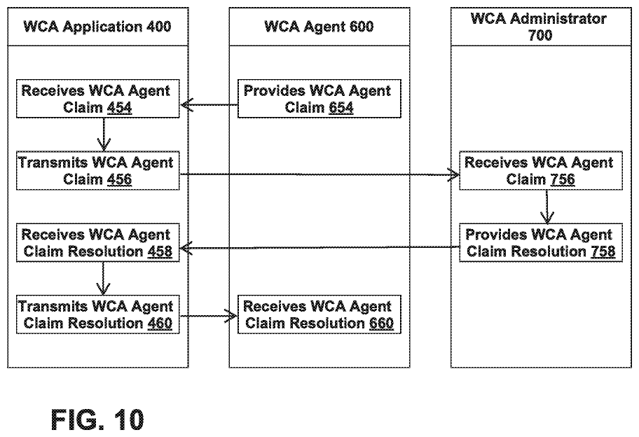

As illustrated in FIG. 10, the WCA application 400 may also be utilized to assist a WCA agent 700 in filing a work related claim and to assist a WCA administrator 700 in addressing the WCA agent's 700 work related claim. If the WCA agent 700 has a work related claim, the WCA agent 700 may utilize the WCA application 400 to notify the WCA administrator 700 of the claim 654, 454, 456, 756). The WCA administrator 700 may provide a resolution to the claim through the WCA application 400 for the WCA agent 600 (758, 458, 460, 660).

Work related claims may include, but is not limited to, claims related to dismissal, discrimination, injury, payroll, work environment, and other claims. The resolution may include, but not limited to, assigning the claim to an attorney or union representative.

WCA application 400 users may use the application to analyze data. For example, the WCA application 400 provides multiple avenues to view data and statistics across the system. For example, users may use the WCA application 400 to display information regarding recent arrival and departure requests including the amount of wheelchairs requested, actual used, and passenger lists. In addition, the system can generate reports on individual flights and passengers that includes detailed timestamp information, wheelchair history, and which agent assisted the passenger. Users may access statistical data related to passenger wait times, arrival flight clear times, and other statistics.

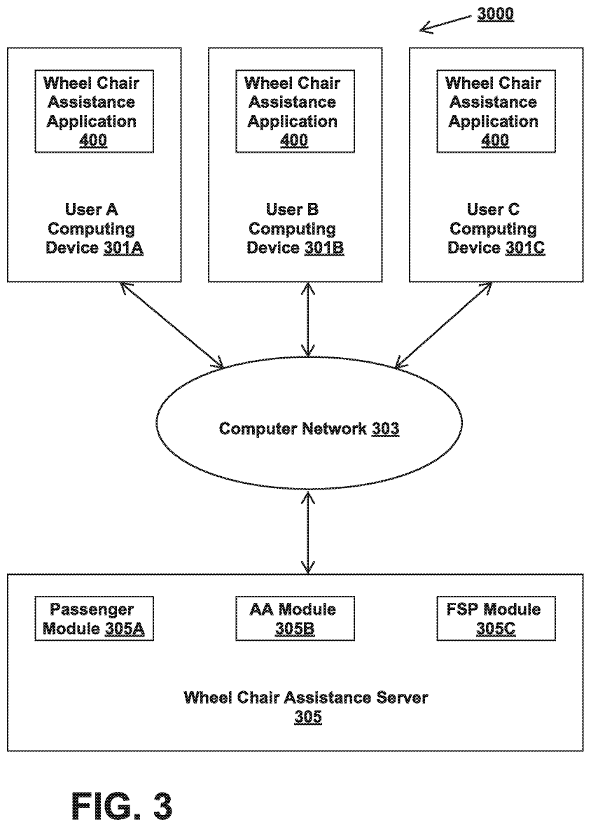

The enabled computing devices 304, 305, 306 may include such devices as tablet computers, smart phones, personal computers, laptop computers, scanners, game consoles and the like. The WCA application 400 may be software designed for airline administrators 200, WCA dispatchers 500, WCA agents 600, and WCA administrators 700 assist passengers 100 in need of a wheelchair at an airport. As illustrated in FIG. 3, the WCA application 400 may also communicate with the WCA server 305 through the computer network 303. The computer network 302 may be, for example, the internet.

The WCA application 400 may contain various modules, including passenger module 305A, the airline administrator module 305B, and the flight status provider module 305C. Additional modules (not shown) may include, but are not limited to, time and attendance modules, human resources modules, billing and payroll modules, training modules, and third-party payer modules (e.g., PayPal). Each module 305A, 305B, 305C may store data. For example, the passenger module 305A may store the passenger information including, but not limited to, the passenger's name, airline, flight number, departing airport name, terminal and gate, arriving airport name, terminal and gate, and other information. The airline administrator module 305B may store airline information including, but not limited to, airline name, airline contact, billing address, billing rates, and other information. The flight status provider module 305C may store the flight status provider information including, but not limited to, flight status provider name, contact number, and other information.

An embodiment of the present invention is a computer system comprising at least one processor unit, at least one memory unit coupled to the at least one processor unit, and, computer readable instructions embodied in the memory unit and executable by the processor unit, wherein execution of the instructions by the processor unit causes the computing system to perform a method of assisting a wheelchair passenger.

The method of assisting a wheelchair passenger comprises receiving passenger information 402, receiving airline information 404, making at least one request of flight status information to at least one flight status provider 406, receiving the flight status information from the at least one flight status provider 408, generating wheelchair assistance information 410, and, providing the wheelchair assistance information to a wheelchair assistance agent 412.

Another embodiment of the present invention is a non-transitory computer readable medium having computer readable instructions embodied therein, the computer readable instructions being configured to implement a method of assisting a wheelchair passenger when executed. “Non-transitory computer readable medium” may not include a transitory signal. The method of assisting a wheelchair passenger comprises receiving passenger information 402, receiving airline information 404, making at least one request of flight status information to at least one flight status provider 406, receiving the flight status information from the at least one flight status provider 408, generating wheelchair assistance information 410, and, providing the wheelchair assistance information to a wheelchair assistance agent 412.

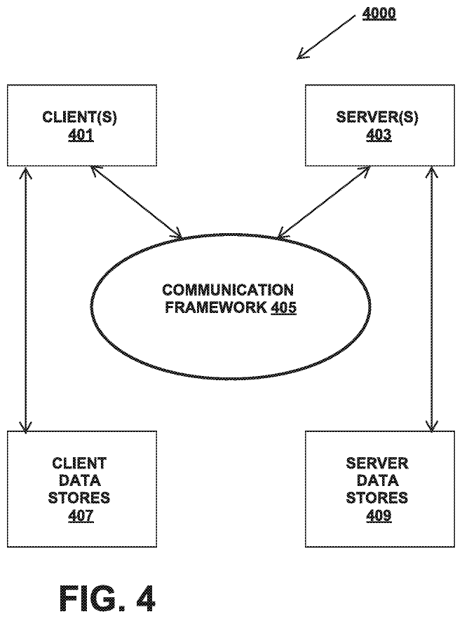

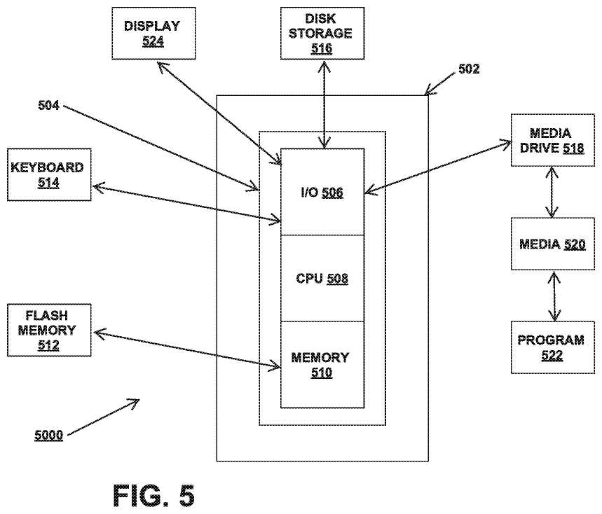

FIGS. 4 and 5 illustrate exemplary computing environments, devices and architectures for the implementation of the various embodiments of the present invention.

FIG. 4 illustrates a sample computing environment 4000 that can be utilized in some embodiments. The system 4000 further illustrates a system that includes one or more client(s) 401. The client(s) 401 can be hardware and/or software (e.g., threads, processes, computing devices). The system 4000 also includes one or more server(s) 403, such as MICA server 305. The server(s) 403 can also be hardware and/or software (e.g., threads, processes, computing devices). One possible communication between a client 403 and a server 403 may be in the form of a data packet adapted to be transmitted between two or more computer processes. The system 4000 includes a communication framework 405 that can be utilized to facilitate communications between the client(s) 401 and the server(s) 403. The client(s) 401 are connected to one or more client data store(s) 407 that can be employed to store information local to the client(s) 401. Similarly, the server(s) 403 are connected to one or more server data store(s) 409 that can be employed to store information local to the server(s) 403.

FIG. 5 depicts an exemplary computing system 5000 that can be configured to perform any one of the above-described processes. In this context, computing system 5000 may include, for example, a processor, memory, storage, and I/O devices (e.g., monitor, keyboard, disk drive, Internet connection, etc.). However, computing system 5000 may include circuitry or other specialized hardware for carrying out some or all aspects of the processes. In some operational settings, computing system 5000 may be configured as a system that includes one or more units, each of which is configured to carry out some aspects of the processes either in software, hardware, or some combination thereof.

FIG. 5 depicts computing system 5000 with a number of components that may be used to perform the above-described processes. The main system 502 includes a motherboard 504 having an I/O section 506, one or more central processing units (CPU) 508, and a memory section 510, which may have a flash memory card 512 related to it. The I/O section 506 is connected to a display 524, a keyboard 514, a disk storage unit 516, and a media drive unit 518. The media drive unit 518 can read/write a computer-readable medium 520, which can contain programs 522 and/or data. Although, not shown, in some embodiments, computing system 5000 can include an eye-tracking system and/or be coupled with an eye-tracking system.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

1. A computer system comprising:
at least one processor unit;
at least one non-transitory memory unit coupled to the at least one processor unit; and,
computer readable instructions embodied in the memory unit and executable by the processor unit, wherein execution of the instructions by the processor unit causes the computing system to perform a method of assisting a wheelchair passenger, the method comprising:
receiving passenger information;
receiving airline information;
making at least one request of flight status information to at least one flight status provider;
receiving the flight status information from the at least one flight status provider;
generating wheelchair assistance information; and,
providing the wheelchair assistance information to a first recipient selected from the group consisting of a wheelchair assistance agent, a wheelchair assistance dispatcher, and combinations thereof.

2. The computer system of claim 1, wherein the method of assisting a wheelchair passenger further comprises providing the wheelchair assistance information to a second recipient selected from a group consisting of an airline administrator, a passenger, and combinations thereof.

3. The computer system of claim 1, wherein the method of assisting a wheelchair passenger further comprises:
receiving wheelchair assistance agent information from the wheelchair assistance agent;
generating a work schedule;
transmitting the work schedule to the wheelchair assistance agent;
receiving time and attendance information from the wheelchair assistance agent; and,
providing the time and attendance information to a wheelchair assistance administrator.

4. The computer system of claim 1, wherein the method of assisting a wheelchair passenger further comprises:
generating billing and invoicing information;
transmitting the billing and invoicing information to a wheelchair assistance administrator;
receiving billing rate information from the wheelchair assistance administrator;
generating an invoice; and,
transmitting the invoice to an airline administrator.

5. The computer system of claim 1, wherein the method of assisting a wheelchair passenger further comprises:
receiving job applicant requirements from a wheelchair assistance administrator; generating a job application;
transmitting the job application to a job applicant;
receiving job applicant qualifications from the job applicant; and,
transmitting the job applicant qualifications to the wheelchair assistance administrator.

6. The computer system of claim 1, wherein the method of assisting a wheelchair passenger further comprises:
receiving wheelchair assistance training information from a wheelchair assistance administrator;
transmitting the wheelchair assistance training information to the wheelchair assistance agent;
receiving a training completion confirmation from the wheelchair assistance agent; and,
transmitting the training completion confirmation to the wheelchair assistance administrator.

7. The computer system of claim 1, wherein the method of assisting a wheelchair passenger further comprises:
receiving a wheelchair assistance agent claim from the wheelchair assistance agent;
transmitting the wheelchair assistance agent claim to a wheelchair assistance administrator;
receiving a claim resolution from the wheelchair assistance administrator; and,
transmitting the claim resolution to the wheelchair assistance agent.

8. A method of assisting a wheelchair passenger, the method comprising:
receiving, via a wheelchair application executing on a processor, passenger information;
receiving, via the wheelchair application, airline information;
making, via the wheelchair application, at least one request of flight status information to at least one flight status provider;
receiving, via the wheelchair application, the flight status information from the at least one flight status provider;
generating, via the wheelchair application, wheelchair assistance information; and,
providing, via the wheelchair application, the wheelchair assistance information to a first recipient selected from the group consisting of a wheelchair assistance agent, a wheelchair assistance dispatcher, and combinations thereof.

9. The method of claim 8, wherein the method of assisting a wheelchair passenger further comprises providing the wheelchair assistance information to a second recipient selected from a group consisting of an airline administrator, a passenger, and combinations thereof.

10. The method of claim 8, wherein the method of assisting a wheelchair passenger further comprises:
receiving wheelchair assistance agent information from the wheelchair assistance agent;
generating a work schedule;
transmitting the work schedule to the wheelchair assistance agent;
receiving time and attendance information from the wheelchair assistance agent; and,
providing the time and attendance information to a wheelchair assistance administrator.

11. The method of claim 8, wherein the method of assisting a wheelchair passenger further comprises:
generating billing and invoicing information;
transmitting the billing and invoicing information to a wheelchair assistance administrator;
receiving billing rate information from the wheelchair assistance administrator;
generating an invoice; and,
transmitting the invoice to an airline administrator.

12. The method of claim 8, wherein the method of assisting a wheelchair passenger further comprises:
receiving job applicant requirements from a wheelchair assistance administrator; generating a job application;
transmitting the job application to a job applicant;
receiving job applicant qualifications from the job applicant; and,
transmitting the job applicant qualifications to the wheelchair assistance administrator.

13. The method of claim 8, wherein the method of assisting a wheelchair passenger further comprises:
receiving wheelchair assistance training information from a wheelchair assistance administrator;
transmitting the wheelchair assistance training information to the wheelchair assistance agent;
receiving a training completion confirmation from the wheelchair assistance agent; and,
transmitting the training completion confirmation to the wheelchair assistance administrator.

14. The method of claim 8, wherein the method of assisting a wheelchair passenger further comprises:
receiving a wheelchair assistance agent claim from the wheelchair assistance agent;
transmitting the wheelchair assistance agent claim to a wheelchair assistance administrator;
receiving a claim resolution from the wheelchair assistance administrator; and,
transmitting the claim resolution to the wheelchair assistance agent.

15. A non-transitory computer readable medium having computer readable instructions embodied therein, the computer readable instructions being configured to implement a method of assisting a wheelchair passenger when executed, the method comprising:
receiving passenger information;
receiving airline information;
making at least one request of flight status information to at least one flight status provider;
receiving the flight status information from the at least one flight status provider;
generating wheelchair assistance information; and,
providing the wheelchair assistance information to a first recipient selected from the group consisting of a wheelchair assistance agent, a wheelchair assistance dispatcher, and combinations thereof.
